(19) United States
(12) Patent Application Publication
(10) Pub. No.: US 2010/0266760 A1
(43) Pub. Date: Oct. 21, 2010

(54) PROCESS FOR THE PRODUCTION OF A COATED PLASTICISING SCREW

(76) Inventors: Hans Berger-Steiner, Gaflenz (AT); Johann Mittmannsgruber, Schwertberg (AT); Gottfried Pockl, Linz (AT)

Correspondence Address: NOTARO, MICHALOS & ZACCARIA P.C., 100 DUTCH HILL ROAD, ORANGEBURG, NY, 10962, US

(21) Appl. No.: 12/424,879

(22) Filed: Apr. 16, 2009

(51) Int. Cl. B05D 3/02; B05D 1/12

(52) U.S. Cl. 427/190; 427/374.4

(57) ABSTRACT

A process for the production of a coated plasticising screw for the injection molding or extrusion of plastic material, wherein at least the wearing surfaces of the plasticising screw are coated with a metal-based alloy, comprising the following steps:

coating at least said wearing surfaces with said alloy,

heating the coated plasticising screw for fusing said alloy to said plasticising screw, and

cooling off said coated plasticising screw,

wherein in the fusing operation all the coated wearing surfaces are simultaneously exposed to a temperature which is above the melting temperature of said alloy.

The present invention concerns a process for the production of a coated plasticising screw for the injection molding or extrusion of plastic material, wherein at least the wearing surfaces of the plasticising screw are coated with a metal-based alloy, comprising the following steps:

coating at least the wearing surfaces with the alloy,

heating the coated plasticising screw for fusing the alloy to the plasticising screw, and

cooling off the coated plasticising screw.

Due to the high material stresses as in conveying, pressing and melting plastic materials in injection molding and extrusion processes the plasticising screws used therein suffer from a high level of wear and as a result have only a limited service life. An increase in the service life is permitted by coating the wearing surfaces with a metal-based alloy as is described in EP 0 542 631. That sets forth a method of applying a nickel-based alloy which contains carbite particles which are dispersed in the matrix of the alloy, to plasticising screws. That procedure requires a plurality of heating operations, wherein in particular fusing of the alloys to the substrate is effected by the local action of heat, which can have a detrimental effect on the stress structure in the material composite and involves the risk of martensitic changes in structure near the surface. As moreover the fusing operation is effected in a rotary apparatus in a horizontal position with simultaneous rotation of the plasticising screw, distortion is to be expected, which leads to the screw not being straight and thus makes it necessary to carry out straightening operations which consequently cause damage to the layer due to crack formation.

The object of the invention is to provide a process which makes it possible to provide a plasticising screw with a high wear-resistant coating which has a high level of adhesive strength to the base material and which can be produced in defect-free or low-defect fashion, wherein the aim is for production to be faster and simpler than in the state of the art.

In the process according to the invention that is achieved in that in the fusing operation all the coated wearing surfaces are simultaneously exposed to a temperature which is above the melting temperature of the alloy.

The process according to the invention therefore realized that metal-based alloys can improve the wearing problems of plasticising screws. Due to the substantially simultaneous process of fusing the alloy to the substrate on the entire wearing surface of the plasticising screw it is possible to avoid a local supply of heat and the temperature differences and stresses which occur in that case. Such avoidance of thermal stresses makes it possible to provide a coating which is substantially free from weak points, and that in turn leads to an increase in the service life.

Further advantageous embodiments of the process according to the invention are defined in the appendant claims.

Preferably straight and stress-free steel bars serve as base material for the plasticising screw on which the process according to the invention is based. Preferably in that respect relatively highly alloyed steels with a carbon content of more than 0.3% are used, which have a relatively high content of the alloying elements chromium, molybdenum, vanadium, tungsten, cobalt, silicon, manganese, aluminum or nickel, which inter alia afford better hardenability and hardness adoption upon being cooled off. Depending on the respective steel used, the brittle martensite is stress-relieved or residual austenite converted by multiple tempering at temperatures of between 400° C. and 600° C.

In the course of the further procedure the screw contour is milled or fly-cut, whereby internal stresses in the material are cut in two. The non-straightness of the material which frequently occurs in the preferably following low-stress annealing at between 550° C. and 650° C. is measured and possibly eliminated by mechanical straightening. Further annealing can remove again the mechanical stresses which occur in that case due to the minor plastic deformation phenomena. Overall a low-stress straight plasticising screw blank is obtained by possibly repeated annealing and straightening.

The plasticising screw and in particular the wearing surfaces thereof can if necessary be cleaned prior to the actual coating operation and preferably be degreased with alcohol. To improve the adhesion properties of the alloy to the substrate it can further be provided that the wearing surfaces of the plasticising screw are roughened by sand blasting for example with high-purity corundum aluminum oxide.

To apply the alloy the plasticising screw is gripped in a suitable machine tool, for example in the rotary table of a coating installation. In a preferred embodiment of the process the alloy is heated in powder form including a spray-and-fuse powder and a hard phase powder in a burner to a temperature of for example 1,200° C. and accelerated so that they impinge at a high speed on the possibly roughened wearing surfaces of the plasticising screws. In that respect it can also be provided that the burner is passed over the wearing surfaces prior to the feed of powder for the removal of any residual moisture that is possibly present, and in that case heats it. In that case, in each spraying pass, between about 5 μm and 20 μm layer thickness is applied. As the plasticising screw is of a complex geometry the sequence of the surfaces to be sprayed and the spray directions can be optimised. Finally, in a plurality of passes in that sequence, all the alloy is applied to the plasticising screw as described in EP 0 801 690 B2.

In that case a sufficient speed in respect of the impinging alloy particles ensures that a pore-free layer is produced even if an optimum impingement angle is not involved in the edge region of the jet. Heat is supplied to the plasticising screw by the impinging jet of alloy particles, and that leads to an increase in the surface temperature. In that respect it can be provided that a constant surface temperature for the plasticising screw of between 120° C. and 170° C. is ensured by means of a cooling device, for example air cooling. An excessively low temperature could lead to problems with moisture, whereas an excessively high temperature could lead to stresses between the layer and the base material and consequently could result in crack formation in the cooling-off operation after the coating procedure. After the application of a layer which is as homogenous as possible, of a thickness of preferably between 0.3 mm and 0.5 mm, over the entire contour of the plasticising screw, it can be cooled to ambient temperature and then measured and protocolled.

Fusing of the layer to the substrate, whereby the mechanical join is converted into a metallurgical join, is effected by heating in a furnace, for example a protective gas or vacuum furnace. Preferably in that case the entire plasticising screw is heated and in a particularly preferred embodiment of the process is supported in a hanging condition and not moved. It is possible in that way to avoid distortion of the screw and rotary movements. To ensure a temperature distribution which is as homogenous as possible on the one hand along the longitudinal axis of the plasticising screw and on the other hand in the interior between the outside diameter and core of the plasticising screw and to avoid large temperature differences the coated plasticising screw can be heated in accordance with a predetermined heating profile. It can be provided in that respect that heating initially is effected as uniformly as possible and prior to the actual fusing procedure for rendering the temperature uniform the plasticising screw is exposed for preferably 30 min to a temperature of 950° C. Thereafter the plasticising screw is further heated to the fusion temperature, which has already been previously established, of between 1,000° C. and 1,150° C. It will be appreciated that the temperature rise times, temperature residence times and the fusion temperature are dependent on the mass and the material of the substrate or the alloy, for example the alloy content of the spray-and-fuse powder and the proportion and composition of the hard phases. In that respect an optimum fusion temperature applies for each alloy mixture, which temperature can be determined for example on the basis of a test series.

After a hold time of preferably 30 min or more when larger dimensions are involved for harmonization of the temperature distribution, the heated plasticising screw is cooled off. In a particularly preferred embodiment of the process it is provided in that respect that the cooling-off operation is effected in accordance with a previously established cooling-off profile in preferably a plurality of steps. The solidification speed of the transport processes in the molten material, which take place during solidification of the molten alloy, determines the fineness of the structure which has an important influence on the hardness of the layer. The further cooling-off speed also has a substantial influence on the layer hardness and thus the wearing resistance and the elongation to fracture of the layer as well as on structure conversion and the properties of the base material of the plasticising screw. In that respect excessively slow cooling leads to soft ferritic structure which cannot withstand the high injection pressures and torques involved in plasticisation of plastic material in injection molding machines. Excessively fast cooling on the other hand leads to high thermal stresses between the base material and the coating. That leads to the formation of cracks which shorten the service life of the plasticising screw, and distortion of the plasticising screw. An optimized cooling-off profile, preferably with a plurality of steps and a variable cooling speed, depending on the respective process which is taking place, permits almost crack-free coating and distortion-free plasticising screws, whereby mechanical straightening of the plasticising screws can become necessary to only a very slight extent.

The example hereinafter illustrates fusion of the alloy to the base material and the subsequent cooling-off procedure in the process according to the invention by reference to a specific example for a plasticising screw of a diameter of 35 mm, comprising the base material 31CrMoV9.

Firstly the plasticising screw coated in accordance with the above-described process is heated in a furnace to a temperature of about 1,095° C. With a holding time of about 30 min, the alloy is fused to the base material. The multi-step cooling off procedure then follows. Firstly, the screw is cooled to a temperature of about 950° at a fall rate of about 200°/h. That is followed by a cooling-off operation at about 500°/h until the plasticising screw reaches a temperature of 550° C. where it is kept for harmonization of the temperature distribution for about 1 h. Finally the plasticising screw is cooled to ambient temperature at a rate of about 400°/h.

It will be appreciated that the process according to the invention is not restricted to that specific embodiment by way of example, nor is it intended to be limited thereby.

Further details and features of the invention are described with reference to the Figures described hereinafter and in which:

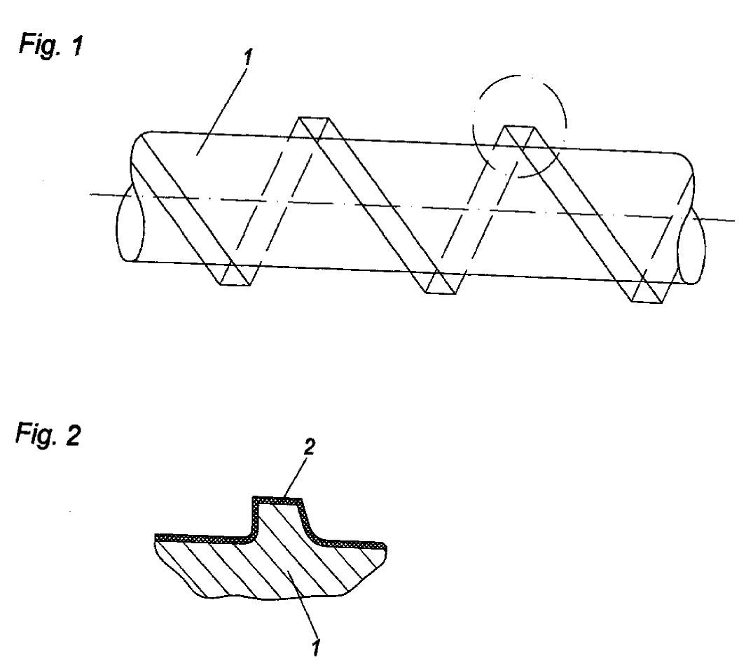

FIG. 1 shows a side view of a plasticising screw according to the invention,

FIG. 2 shows a detail view of the portion of a plasticising screw according to the invention, as marked by a circle in FIG. 1,

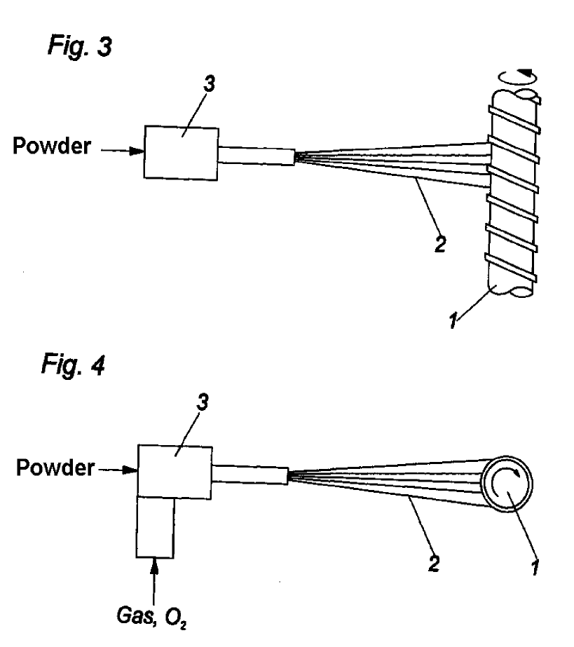

FIG. 3 shows a side view of the procedure of coating a plasticising screw with the alloy, and

FIG. 4 shows a plan view of the procedure of coating a plasticising screw with the alloy.

FIG. 1 shows a side view of a plasticising screw 1 according to the invention. The portion marked by a circle is shown as a detail view in FIG. 2. It is possible to see here the applied alloy 2. FIG. 3 diagrammatically shows a side view illustrating the procedure of coating the plasticising screw. In this embodiment of the process according to the invention the alloy 2 is fed in powder form to a burner 3 and then sprayed onto the rotating plasticising screw. The plan view in FIG. 4 additionally shows the gas feed for a burner 3 which is preferably used.

1. A process for the production of a coated plasticising screw for the injection molding or extrusion of plastic material, wherein at least the wearing surfaces of said plasticising screw are coated with a metal-based alloy, comprising the following steps:
coating at least said wearing surfaces with said alloy,
heating the coated plasticising screw for fusing said alloy to said plasticising screw, and
cooling off said coated plasticising screw,
wherein in the fusing operation all the coated wearing surfaces are simultaneously exposed to a temperature which is above the melting temperature of said alloy.

2. A process as set forth in claim 1 wherein the entire coated plasticising screw is simultaneously exposed to a temperature which is above the melting temperature of said alloy.

3. A process as set forth in claim 1 wherein said plasticising screw is supported substantially perpendicularly during the heating operation for the fusion step.

4. A process as set forth in claim 1 wherein said plasticising screw is not moved during the heating operation for the fusion step.

5. A process as set forth in claim 1 wherein said heating step is effected in accordance with a predetermined heating profile.

6. A process as set forth in claim 5 wherein the temperature to which the plasticising screw is exposed during the fusion step is in a range of between 1,000 and 1,150° C.

7. A process as set forth in claim 5 wherein prior to the actual fusion step the plasticising screw is exposed to a temperature of about 950° C., preferably for about 30 min.

8. A process as set forth in claim 7 wherein prior to the actual fusion step the plasticising screw is exposed to a temperature of about 950° C. for about 30 min.

9. A process as set forth in claim 5 wherein the temperature to which the plasticising screw is exposed during the fusion step is maintained for about 30 min.

10. A process as set forth in claim 1 wherein the cooling-off procedure is effected in accordance with a predetermined cooling-off profile.

11. A process as set forth in claim 1 wherein the coating of said plasticising screw is effected by spraying on a powder which includes said alloy.

12. A process as set forth claim 11 wherein the spraying-on operation is effected in accordance with a previously established sequence of the wearing surfaces, which are to be sprayed, of said plasticising screw.

13. A process as set forth in claim 11 wherein the powder is heated in a burner before the spraying-on operation.

14. A process as set forth in claim 13 wherein prior to the coating operation said burner is passed at least once without a feed of powder over the surface of the plasticising screw to remove the residual moisture.

15. A process as set forth in claim 11 wherein a surface temperature of said plasticising screw of between 120° C. and 170° C. is ensured by the heat supplied by the operation of spraying on the powder.

16. A process as set forth in claim 15 wherein a cooling process is involved to ensure said surface temperature of said plasticising screw of between 120° C. and 170° C.

17. A process as set forth in claim 11 wherein said plasticising screw is cooled to ambient temperature after the coating operation.

18. A process as set forth in claim 1 wherein the wearing surfaces of said plasticising screw are cleaned prior to the coating operation.

19. A process as set forth in claim 16 wherein the cleaning operation includes degreasing of the wearing surfaces of said plasticising screw.

20. A process as set forth in claim 1 wherein the wearing surfaces of said plasticising screw are roughened by sand blasting.

21. A process as set forth in claim 20 wherein the wearing surfaces of said plasticising screw are roughened by sand blasting by means of high-purity corundum aluminum oxide.
